(19) United States
(12) Patent Application Publication
(10) Pub. No.: US 2024/0228692 A9
(43) Pub. Date: Jul. 11, 2024

(54) IMPROVED SILICON CONTAINING POLYISOCYANATE POLYADDITION (PIPA) POLYOL PRODUCTION AND POLYURETHANE FOAMS CONTAINING THE SAME

(71) Applicant: Dow Global Technologies LLC, Midland, MI (US)

(72) Inventors: Hamideh Ahmadloo, Horgen (CH); Nebojsa Jelic, Wangen (CH); Paul Cookson, Cheadle (GB); Oguz Türünç, Terneuzen (NL); Nasim Hooshyar, Terneuzen (NL)

(21) Appl. No.: 18/546,857

(22) PCT Filed: May 19, 2022
(86) PCT No.: PCT/US2022/029989

§ 371 Date: Aug. 17, 2023

Related U.S. Application Data
(60) Provisional application No. 63/197,574, filed on Jun. 7, 2021.

(51) Int. Cl. C08G 18/50; C08G 18/20; C08G 18/24; C08G 18/30; C08G 18/48; C08G 18/76; C08J 9/12

(52) U.S. Cl. CPC C08G 18/5096; C08G 18/2027; C08G 18/246; C08G 18/302; C08G 18/4841; C08G 18/5045; C08G 18/7614; C08J 9/125; C08G 2110/0008; C08G 2110/0083; C08J 2205/06; C08J 2375/04

(57) ABSTRACT

Provides a silicon containing polyisocyanate polyaddition (PIPA) polyether polyol dispersion at readily processible viscosity for use in making flexible polyurethane foams having inherent flame retardant properties that comprises polyether polyol carrier and from 10 to 25 wt. %, based on total weight of dispersion, of particles of a silicon containing (PIPA) polyether polyol having a particle size diameter wherein 90%, by volume, of the particles in dispersion have maximum PSD of from 0.1 to 3 m and that, further, contain two or more aromatic carbamate groups. Dispersion may further comprise water or blowing agent, i) one or more catalysts, and f) one or more polyisocyanates in a foam forming mixture. In addition, provides methods for making the silicon containing PIPA polyether polyol dispersion comprising forming and mixing under shear a base polyol dispersion and delaying the addition of g) one or more polyisocyantes and h) a catalyst while mixing under shear.

The present invention relates to stable dispersions of polyether polyols containing silicate and carbamate groups in a polyether polyol carrier for use in making flexible polyurethane foams having inherent flame retardant properties, to the foams themselves, and to methods of making the foams. More particularly, it relates to polyol dispersions of polyisocyanate polyaddition (PIPA) polyether polyol particles that contain silicon, and that further contain carbamate groups, wherein the silicon containing PIPA polyether polyol particles have a particle size diameter (PSD) wherein 90%, by volume, of the particles in the dispersion have a maximum PSD of from 0.1 to 3 μm, as determined by laser light scattering, and are dispersed in a polyether polyol carrier, and, further wherein, the polyether polyol in the polyol dispersion reacts with a polyisocyanate to form polyurethane foams comprising non-migrating flame retardants and that exhibit improved inherent flame resistance or flame retardant (FR) properties.

Recent regulations require that FR improving substances or FR additives that don't migrate out of the foam as opposed to added solid or liquid non-reactive flame retarding additives. Some dispersions known for enabling the making of polyurethane foams can provide foams that pass Crib 5 (British Standard BS 5852:2006) bulk flame fire tests without a flame retardant additive. Such foams thus may be said to provide some measure of inherent flame retardant properties. However, such known dispersions, including prepolymer dispersions, for example, Polyharnstoff Dispersion (PHD) polyols, as well as PIPA polyols, fail to provide foams having inherent FR properties in open ignition FR tests such as CAL 117 test (Cal. State Technical Bulletin 117, 2000). Thus, there remains a need for foams having improved non-migrating flame retardant properties.

Unlike other known fire retardant polymer materials, such as styrene acrylonitrile (SAN) polymers which are essentially devoid of reactive sites, PIPA polyols carry significant numbers of functional groups that react readily with isocyanate components of a polyurethane foam making formulation and so react in to the foams made therefrom. Thus, the PIPA particles participate in the foam curing reaction, thereby enabling solid materials which have inherent FR properties, i.e. in themselves, and enabling sustainable solutions in compliance with recent regulations. However, it would be desirable to improve PIPA polyol inherent FR properties and to remove or decrease FR additives in polyurethane foams.

Recently, World Intellectual Property Organization (WIPO) publication WO2019/118693 A1 to Turunc et al., has disclosed flexible polyurethane foams made from a polyisocyanate and a polyol dispersion containing a silicate. The disclosure suggests that the inventive foams enable improve flame retardant properties. However, the foams disclosed in Turunc do not pass both open flame and bulk flame fire resistance tests. There remains a need for inherently flame retardant foams that have non-migrating flame retardant materials and that pass both open flame and bulk flame fire resistance tests.

In accordance with the present invention, the present inventors have solved the problem of providing a polyol composition that enables the formation of a flame retardant polyurethane foam that comprises a non-migrating flame retardant and which exhibits both the bulk and open flame retardancy.

### STATEMENT OF THE INVENTION

In accordance with the present invention, a silicon containing PIPA polyether polyol dispersion for use in making flexible polyurethane foams having inherent flame retardant properties comprises a polyether polyol carrier and from 10 to 25 wt. %, based on the total weight of the dispersion, of particles of a silicon containing polyisocyanate polyaddition (PIPA) polyether polyol that contain one or more silicate groups and one or more alkoxy silane, silanol and/or oxyalkylenoxy silane groups, preferably, both, and that, further, contain two or more carbamate groups, preferably, each group comprising an aromatic carbamate, wherein the silicon containing PIPA polyether polyol particles have a particle size diameter (PSD) wherein 90%, by volume, of the particles in the dispersion have a maximum PSD of from 0.1 to 3 μm, or, preferably, from 0.2 to 1.5 μm, as determined by laser light scattering, and, further wherein, the dynamic viscosity of the dispersion as determined in accordance ASTM D4878 (2015) at 25° C. ranges from 1500 to 5000 cP or, preferably, from 2000 to 3600 cP. The silicon containing groups in the silicon containing PIPA polyether polyol dispersion may comprise any of silicate, alkoxy silane, oxyalkylenoxy silane, or silanol groups. The silicon containing PIPA polyether polyol particles may further comprise nitrogen or phosphorous containing groups, such as amines or phosphoesters, preferably an amine, more preferably, a tertiary amine. Further, the silicon containing PIPA polyether polyol particles may comprise, in polymerized or condensed form, c) one or more compatible seed polyols as a dispersion having a particle size diameter (PSD) wherein 90%, by volume, of the particles in the dispersion have a maximum PSD of 10 μm or less, or, preferably, from 5 μm or less, or, more preferably, 3 μm or less, as determined by laser light scattering, for example, a particulate branched polyether seed polyol containing two or more carbamate groups, in particular, a PIPA polymer seed polyol containing two or more aromatic carbamate groups. Still further, the silicon containing PIPA polyether polyol particles may comprise, in polymerized or condensed form, d) a co-reactant polyol having an hydroxyl equivalent weight of up to 400 and containing a nitrogen atom, such as an alkanolamine, preferably, triethanolamine.

Preferably, the polyether polyol carrier comprises b) one or more ethoxylated or oxyethylene end-capped polyols having a number average molecular weight of from 2000 to 12,000, or, more preferably, from 2500 to 7000 and an average hydroxyl functionality of from 2 to 8, or, more preferably, from 2 to 6, or, even more preferably, from 2 to 3.5, or, yet even more preferably, a nominal hydroxyl functionality of three. The preferred b) ethoxylated or oxyethylene end-capped polyether polyol carrier has an ethylene oxide content of at least 15 wt. %, or, preferably, up to 80 wt. %, based on the total weight of alkylene oxides or alkylene oxide containing reactants used to form the polyether polyol carrier.

The silicon containing PIPA polyether polyol dispersion in accordance with the present invention may further comprise:
water or another blowing agent,
i) one or more catalysts, such as a tertiary amine or a tin catalyst, and,
g) as a separate component, a polyisocyanate, such as an aromatic polyisocyanate or aromatic diisocyanate, wherein a mixture of the silicon containing PIPA polyether polyol dispersion and the separate polyisocyanate component comprises a foam forming mixture. The foam forming mixture may have an isocyanate index of from 60 to 150.

The foam forming mixture provides a flexible polyurethane foam in accordance with the present invention exhibits one or more, or all, of (i) a Cal State Technical Bulletin 117, 2000 (CAL117) open flame Char length test rating of 10 cm or less, and (ii) a CAL 117, After Flame test with a rating of 5 s or less, and, further, the flexible polyurethane foam exhibits one or more, or all, of (i) a bulk flame Crib 5 British Standard BS 5852:2006 test standard (Crib 5), Time to Extinguish test rating of less than 600 s, preferably, less than 450 s, (ii) a Crib 5, Weight Loss test rating of less than 60 g, (iii) a self-extinguishing material rating as determined in accordance with Crib 5, and (iv) a Crib 5, Burn through base rating of “No burn”.

Further, in accordance with the present invention methods of making the silicon containing polyisocyanate polyaddition (PIPA) polyether polyol dispersion, such as, for example, one wherein the silicon containing PIPA polyether polyol particles have a particle size diameter (PSD) wherein 90%, by volume, of the particles in the dispersion have a maximum PSD of from 0.1 to 3 μm, or, preferably, from 0.2 to 1.5 μm, as determined by laser light scattering, and, further wherein, the dynamic viscosity of the dispersion as determined in accordance ASTM D4878 (2015) at 25° C. ranges from 1500 to 5000 cP or, preferably, from 2000 to 3600 cP, comprise:
forming a polyol mixture under shear while heating to reach a temperature of from 40 to 70° C. of a) from 10 to 25 wt. %, based on the total weight of the polyol mixture, of at least one alkoxysilane in which the alkoxy groups each independently contain 1 to 4 carbon atoms, b) from 53 to 80 wt. %, based on the total weight of the polyol mixture, of one or more polyether polyols having a hydroxyl equivalent weight of from 500 to 4000 and an average of from 2 to 8, or, preferably, from 2 to 6, or, more preferably, from 2 to 3.5 hydroxyl groups per molecule, or, even more preferably, a nominal hydroxyl functionality of three, such as an ethoxylated or oxyethylene end-capped polyol, and e) water in the amount of from 2 to 5 moles per mole of the a) at least one alkoxysilane to form a homogeneous dispersion;
slowly adding under shear while maintaining the temperature for forming the polyol mixture, such as dropwise over a period of from 1 to 8 hours, f) a catalyst for the reaction of the alkoxysilane and water, such as a volatile catalyst, preferably, ammonia or aqua ammonia, to form a reaction mixture;
stripping the reaction mixture to remove residual water and volatiles at from 50 to 80° C. and reduced pressure to form a base polyol dispersion of a silicon containing polyether polyol that contains one or more silicate, alkoxy silane, or oxyalkylenoxy silane groups in a polyether polyol carrier;
mixing under shear the base polyol dispersion for a first period of from 45 to 180 seconds; and,
at the end of the first period, adding to the base polyol dispersion under continued mixing under shear g) one or more polyisocyanates, such as a diisocyanate, preferably, an aromatic diisocyanate, in an amount to provide an isocyanate index of from 50 to less than 100 with the base polyol dispersion, such as from 50 to 90, or, preferably, from 60 to 90 and h) a catalyst, such as tin free catalyst or a divalent metal salt, preferably, a zinc fatty acid salt, in the amount of from 0.1 to 0.5, or, preferably from 0.2 to 0.4 wt. %, based on the total weight of the base polyol dispersion, and
continuing the mixing under shear until the exotherm of the homogeneous dispersion ceases, thereby producing a silicon containing PIPA polyether polyol dispersion in a continuous phase of a polyol. Acceptable shear rates may range from 8 to 60 s⁻¹, or, preferably, from 10 to 40 s⁻¹. All wt. % s in the polyol mixture add to 100%, with the polyol mixture not including water. Preferably, adding the h) catalyst takes place after a second period of from 30 to 90 seconds beginning at the end of the first period. Further, to provide silicon containing PIPA polyether polyols for use in making high resilience foams, the hydroxyl groups in the polyol mixture may comprise at least 45 wt. %, or, preferably, at least 75 wt. % of primary hydroxyl groups, based on the total weight of hydroxyl groups in the polyol mixture.

Preferably, the base polyol dispersion further comprises a) at least one alkoxysilane, b) one or more ethoxylated or oxyethylene end-capped polyols having a number average molecular weight of from 2000 to 12000, or, more preferably, from 2500 to 7000 and an average hydroxyl functionality of from 2 to 8, or, more preferably, from 2 to 6, or, even more preferably, from 2 to 3.5, or, yet even more preferably, a nominal hydroxyl functionality of three, c) from 1 to 4 wt. %, or preferably, from 2 to 4 wt. %, based on the total weight of the polyol mixture, of one or more compatible seed polyols having a particle size diameter (PSD) wherein 90%, by volume, of the particles in the dispersion have a maximum PSD of 10 μm or less, or, preferably, 5 μm or less, or, more preferably, 3 μm or less, as determined by laser light scattering, for example, a particulate branched polyether seed polyol containing two or more carbamate groups, preferably, a PIPA polyether seed polyol, or, more preferably, a PIPA polyether seed polyol containing two or more aromatic carbamate groups, and d) one or more co-reactant polyols having an hydroxyl equivalent weight of up to 400, preferably, containing at least one nitrogen atom, more preferably a tertiary nitrogen atom.

Preferably, in accordance with the present invention the methods of making the silicon containing PIPA polyether polyol dispersion from a base polyol dispersion of a silicon containing polyether polyol particles comprising one or more silicate, alkoxy silane, or oxyalkylenoxy silane groups in a polyether polyol carrier takes place in two or more steps and comprises:
mixing the base polyol dispersion under shear while heating to a temperature of from 40 to 70° C. for a first period of 40 to 120 seconds,
adding to the at the end of the first period while continuing the mixing under shear g) one or more polyisocyanates, such as a diisocyanate, preferably, an aromatic diisocyanate, in an amount to provide an isocyanate index of from 50 to less than 100, such as from 50 to 90, or, preferably, from 60 to 90, and h) a catalyst, such as tin free catalyst or a divalent metal salt, preferably, a zinc fatty acid salt, in the amount of from 0.1 to 0.5, or, preferably from 0.2 to 0.4 wt. %, based on the total weight of the base polyol dispersion, and
continuing the mixing under shear until the exotherm of the homogeneous dispersion ceases. Preferably, adding the h) catalyst takes place after a second period of from 30 to 90 seconds beginning at the end of the first period. Acceptable shear rates may range from 8 to 60 s⁻¹, or, preferably, from 10 to 40 s⁻¹. Further, to provide silicon containing PIPA polyether polyols for use in making high resilience foams, the hydroxy groups in the polyol mixture may comprise at least 45 wt. %, or, preferably, at least 75 wt. % of primary hydroxyl groups, based on the total weight of hydroxyl groups in the polyol mixture.

In another aspect of in accordance with the present invention, a flexible polyurethane foam having inherent flame retardant (FR) properties comprises the reaction product of a foam forming mixture of the silicon containing PIPA polyether polyol dispersion and a polyisocyanate, such as an aromatic polyisocyanate or aromatic diisocyanate. The foam forming mixture may have an isocyanate index of from 60 to 150. The flexible polyurethane foam in accordance with the present invention exhibits one or more, or all, of (i) a Cal State Technical Bulletin 117, 2000 (CAL117) open flame Char length test rating of 10 cm or less, and (ii) a CAL 117, After Flame test with a rating of 5 s or less, and, further, the flexible polyurethane foam exhibits one or more, or all, of (i) a bulk flame Crib 5 British Standard BS 5852:2006 test standard (Crib 5), Time to Extinguish test rating of less than 600 s, preferably, less than 450 s, (ii) a Crib 5, Weight Loss test rating of less than 60 g, (iii) a self-extinguishing material rating as determined in accordance with Crib 5, and (iv) a Crib 5, Burn through base rating of “No burn”. Further, the flexible polyurethane foam in accordance with the present invention maintains a stable white color after more than 1-month direct exposure to sun light.

### DETAILED DESCRIPTION OF THE INVENTION

The present invention provides polyether polyol dispersions comprising silicon containing polyisocyanate polyaddition (PIPA) polyether polyol particles that enable the provision of flexible polyurethane foams, such as high resilience polyurethane foams, having improved flame retardant (FR) properties. In addition, the present invention provides methods of making a polyether polyol dispersion comprising improving the stability of a silicon containing polyether polyol carrier by heating a polyol mixture containing an alkoxysilane prior to the addition of f) a hydrolysis catalyst, such as a volatile catalyst, preferably, ammonia, and stirring or shearing while adding the catalyst to form the silicon containing polyether polyol carrier. The present invention also improves the reactivity of a silicon containing PIPA polyether polyol in making silicon containing PIPA polyether polyol dispersions and foams made therefrom by delaying the addition of an isocyanate and h) a catalyst for forming urethanes. Because the silicon containing PIPA polyether polyol dispersion comprises particles uniformly dispersed in a polyol, the foam products resulting from their reaction with polyisocyanates comprise a homogeneous dispersion of silicon containing material particles in the foam. The silicon containing material particles provide a flame retardant effect and are non-migrating because they are reacted into and form part of the foam matrix. The polyether polyol dispersion of the present invention enables one to provide—tin-free polyurethane foams that pass both the bulk flame Crib 5 British Standard BS 5852:2006 test and the Cal 117 (2000) open flame tests, preferably without FR additives.

All ranges recited are inclusive and combinable. For example, a disclosed dynamic viscosity of from 1500 to 5000 cP at ambient temperature, preferably, from 2000 to 3600 cP, would include from 1500 to 5000 cP, or from 1500 to 3600 cP, or from 1500 to 2000 cP, or from 3600 to 5000 cP, or from 2000 to 5000 cP or, preferably, from 2000 to 3600 cP.

Unless otherwise indicated, conditions of temperature and pressure are ambient temperature (21-24° C.), a relative humidity of 50%, and standard pressure (1 atm).

Unless otherwise indicated, any term containing parentheses refers, alternatively, to the whole term as if parentheses were present and the term without them, and combinations of each alternative. Thus, as used herein the term, “(poly)diol” and like terms is intended to include the diol, a polymer or oligomer of the diol, and their mixtures.

As used herein, the term “ASTM” refers to publications of ASTM International, Conshohocken, Pa.

As used herein the term “CAL 117” refers to the Technical Bulletin 117, “Test Procedure and Apparatus for Testing the Flame Retardance of Resilient Filling Materials Used in Upholstered Furniture”, State of California, Dept. of Consumer Affairs Bureau of Home Furnishings and Thermal Insulation, North Highlands, CA, March 2000.

As used herein the term “Crib 5” refers to the upholstery filling test, ignition source 5, British Standard BS 5852:2006, “Methods of test for assessment of the ignitability of upholstered seating by smouldering and flaming ignition sources”, British Standards (BSI), London, U K, 2006.

As used herein, the term “component” refers to a composition containing one or more ingredients which is combined with another component to start a reaction, polymerization, foam formation or cure. Components are kept separate until combined at the time of use or reaction.

As used herein, the term “DIN” refers to publications of the Deutsches Institut fur Normung, the German Institute for Standardization, Berlin, Germany.

As used herein, the term “ISO” refers to the publications of the International Organization for Standardization, Geneva, CH.

As used herein, the term “dynamic viscosity” of the dispersion as determined in accordance ASTM D4878 (2015) using a Bohlin C-VOR Rheometer (Malvern, Worcestershire, UK) equipped with a DIN C25 coaxial cylinder having a bob diameter of 25 mm.

As used herein, the term “exotherm” refers to heat generated by a reaction that results in a rising or a least a steady elevated temperature (above room temperature) without the addition of any heat.

As used herein, the term “hydroxyl number” in mg KOH/g analyte refers to the amount of KOH needed to neutralize the acetic acid taken up on acetylation of one gram the analyte material.

As used herein, unless otherwise indicated, the term “isocyanate index” refers to the ratio of the number of equivalents of isocyanate functional groups to hydroxyl groups in a given polyurethane forming mixture, multiplied by 100 and expressed as a number. For example, in a mixture wherein the number of equivalents of isocyanate equals the number of equivalents of hydroxyl groups, the isocyanate index is 100.

As used herein, the term “nominal hydroxyl functionality” refers to the number of hydroxyl groups in an ideal formula of a given diol or polyol, which is not respective of impurities or variability in the formula. The nominal hydroxyl functionality of a poly(oxyalkylene ether), for example, is two. The term “nominal hydroxyl functionality” and “formula hydroxyl functionality” can be used interchangeably. The term “average hydroxyl functionality” refers to the weight average of the nominal hydroxyl functionality of a mixture of hydroxyl functional compounds. For example, a 50/50 w/w mixture of ethylene glycol and glycerol has an average hydroxyl functionality of 0.5(2 nominal OH groups in ethylene glycol)+0.5(3 nominal OH groups in glycerol) or 2.5.

As used herein, the term “number average molecular weight” or “Mₙ” of a given polyether polyol or polyol refers to the number average value taken from the weight distribution of the polyol as determined by 13C-NMR molecular identification, followed by gel permeation chromatography (GPC) of a 20 wt. % aqueous solution of the given polyol, calibrated using a polyether polyol standard, such as polyethylene glycol.

As used herein, the phrase “particle size” or “particle size diameter (PSD)” means the particle size diameter of a given material dispersion, as determined by laser light scattering, and is reported as the % by volume of the particles in the dispersion having a specified maximum particle diameter.

As used herein, the term “polyisocyanate” refers to an isocyanate group containing material having two or more isocyanate functional groups, such as a diisocyanate, or a biuret, allophanate, isocyanurate, carbodiimide, dimer, trimer or oligomer thereof made by reaction of an excess of isocyanate with one or more diols.

As used herein, the term “total solids” or “solids” refers to everything in a given composition other than water and volatile solvents which flash off or volatilize at below 40° C. and atmospheric pressure.

As used herein, the phrase “wt. %” stands for weight percent.

As used herein, the term “×90” means the 90^{th} percentile of a given parameter measured or observed in a dispersion or distribution of a material.

In accordance with the present invention a silicon containing polyisocyanate polyaddition (PIPA) polyether polyol is dispersed as particles in an amount of from 10 to 25 wt. %, based on the total weight of the dispersion in a polyether polyol carrier and provides foams with non-migrating flame retardants. Each of the PIPA polyether polyol particles comprise the hydrolysis or etherification residue of an alkoxy silane, such as a tetraalkoxy silane, such as tetraethoxy silane (TEOS). Such hydrolysis or etherification residues may include any of silicate, alkoxy silane, or oxyalkylenoxy silane groups. Upon reaction with a polyisocyanate in a foaming reaction, the PIPA polyol dispersion in accordance with the present invention provides foams with non-migrating flame retardants, preferably, without any flame retardant (FR) additives.

The silicon containing PIPA polyether polyol dispersion in accordance with the present invention comprises the particulate reaction product of g) a polyisocyanate and a base polyol dispersion of a silicon containing polyether polyol in a polyether polyol carrier. The base polyol dispersion is formed when a polyol mixture of a) at least one alkoxysilane, b) one or more ethoxylated or oxyethylene end-capped polyols or polyether polyols, c) one or more compatible seed polyols, d) one or more co-reactant polyols is formed in the presence of f) an aqueous catalyst for the reaction of the alkoxysilane and water, such as an aqueous acid or a base catalyst, preferably a volatile catalyst like ammonia. The silicon containing PIPA polyether polyol dispersion of the present invention results from reaction of the silicon containing polyether polyol in the base polyol dispersion and an isocyanate in a polyether polyol, preferably in the presence of h) a tin-free catalyst.

In accordance with the present invention, the polyol mixture comprises a) from 10 to 25 wt. %, or, preferably, from 12 to 24 wt. % of at least one alkoxysilane in which the alkoxy groups each independently contain 1 to 4 carbon atoms, preferably, 1 or 2 carbon atoms, b) from 53 to 80 wt. % or, preferably, from 57 to 80 wt. %, of one or more polyether polyols each having a hydroxyl equivalent weight of from 500 to 4000 or a number average molecular weight of from 2000 to 12000, or from 2500 to 7000, and having an average of from 2 to 8, or, more preferably, from 2 to 6, or, even more preferably, from 2 to 3.5 hydroxyl groups per molecule, or, yet even more preferably, a nominal hydroxyl functionality of three, such as an ethoxylated or oxyethylene end-capped polyol, c) from 1 to 4 wt. %, or, preferably, from 2 to 4 wt. % of one or more compatible seed polyols having a weight average particle size of less than 2.5 μm, for example, a particulate branched polyether seed polyol containing two or more carbamate groups, preferably, a PIPA polyether seed polyol containing two or more carbamate groups, or, more preferably, a PIPA polyether seed polyol containing two or more aromatic carbamate groups, and, d) from 6 to 18 wt. % or, preferably, from 8 to 15 wt. % of one or more co-reactant polyols having an hydroxyl equivalent weight of up to 400, more preferably, containing at least one nitrogen atom, such as, preferably, triethanolamine, all wt. % s based on the total weight of the polyol mixture and all wt. % s in the polyol mixture, excluding water, add up to 100%. The polyol mixture becomes a reaction mixture when an aqueous f) catalyst is added with shearing to the polyol mixture. Most of the b) one or more polyether polyols in the silicon containing PIPA polyether polyol dispersion act as a carrier phase in the dispersion.

The a) at least one alkoxysilane in accordance with the present invention may comprise any alkoxy silane having from 1 to 4 alkoxy groups, preferably, 3 or 4 alkoxy groups, wherein the alkoxy group has from 1 to 4 carbon atoms, preferably 1 or 2 carbon atoms. Specific examples of suitable alkoxysilane compounds may include, for example, tetraalkoxysilanes such as tetramethoxysilane, tetraethoxysilane, tetrapropoxysilane, tetraisopropoxysilane, tetrabutoxysilane and the like; trialkoxyalkylsilanes, such as methyltrimethoxy silane, methyltriethoxy silane, methyltripropoxy silane, methyltributoxysilane, ethyltrimethoxysilane, ethyltriethoxysilane, n-propyltrimethoxysilane, n-propyltriethoxysilane, isopropyltrimethoxysilane, isopropyltriethoxysilane dialkoxydialkylsilanes dimethyldimethoxysilane, dimethyldiethoxysilane, diethyldimethoxysilane and diethyldiethoxysilane, and partial condensates thereof. Preferred alkoxysilanes include tetramethoxysilane, tetraethoxysilane (TEOS), methyltrimethoxy silane, methyltriethoxysilane, ethyltrimethoxysilane, ethyltriethoxysilane, n-propyltrimethoxysilane, and n-propyltriethoxysilane.

The polyisocyanate polyaddition (PIPA) polyether polyol dispersion of the present invention comprises one or more polyether polyol carriers which are polyether polyols that also partially react into the PIPA polyether polyol and/or foam made therefrom. Each of the b) one or more polyether polyols in accordance with the present invention may have a hydroxyl equivalent weight of from 500 to 4000 and an average of from 2 to 8, or, more preferably, from 2 to 6, or, even more preferably, from 1.8 to 3.5 hydroxyl groups per molecule. Suitable such polyether polyols may be one or more ethoxylated or oxyethylene end-capped polyols, such as an ethoxylated or oxyethylene end-capped polyol, that has an ethylene oxide content of at least 15 wt. %, or, preferably, up to 80 wt. %, based on the total weight of alkylene oxides used to form the polyether polyol carrier. Such a polyether polyol may be b) an ethoxylated or oxyethylene end-capped polyol having a number average molecular weight (Mₙ) of from 2000 to 12000, preferably, from 4000 to 7000 and an average hydroxyl functionality of from 2 to 8, or, more preferably, from 2 to 6, or, even more preferably, from 2.4 to 3.5 groups, such as a nominal hydroxyl functionality of three. Mixtures of two or more of the foregoing initiators may be used. For example, the initiator may be glycerin. Suitable polyether polyol carriers include the product of oxyalkylene addition of an oxyalkylene feed in the presence of one or more initiators, such as a triol or a triamine, or a mixture of one or more initiators, such as a triol or triamine with one or more of a tetraol, tetramine, diamine or a diol, followed by advancing the product to the desirable number average molecular weight and ethylene oxide proportion by oxyethylene addition. Examples of suitable initiators include compounds with from two to four hydroxyl groups, primary amine groups, or secondary amine groups. Suitable initiators may include glycerin, trimethylolpropane, triethylolpropane, trimethylol ethane, triethanolamine, and other triols; suitable tetraols may include, for example, erythritol; suitable diols may include, for example, diols and diamines having a molecular weight of 120 or higher, or, 140 or, higher, such as monoesters of glycerol (mono-glycerides) and propane diamine. Catalysts for the addition reaction to form the ethoxylated or oxyethylene end-capped polyol can be anionic or cationic, such as potassium hydroxide (KOH), cesium hydroxide (CsOH), boron trifluoride, or a double metal cyanide complex (DMC) catalyst, such as zinc hexacyanocobaltate or a quaternary phosphazenium compound. When alkaline catalysts are used, they are preferably removed from the polyol at the end of production by a finishing step, such as coalescence, magnesium silicate separation or acid neutralization.

Examples of suitable b) ethoxylated or oxyethylene end-capped polyols may include a poly(ethylene oxide-co-propylene oxide) copolymer triol (glycerin initiated) having 19 wt. % of ethylene oxide in the alkylene oxide feed, an hydroxyl number of 35.5, a primary hydroxyl content of approximately 88% and a hydroxyl equivalent weight of 1580 (Mₙ ˜4750), or it may include a poly(ethylene oxide-co-propylene oxide) copolymer triol (glycerin initiated) having 70 wt. % of ethylene oxide in the alkylene oxide feed, a hydroxyl number of 34, a primary hydroxyl content of approximately 48% and an hydroxy equivalent weight of 1650 (Mₙ ˜4950). An example of a commercially available ethoxylated or oxyethylene end-capped polyol is available as a VORANOL™ polyol (The Dow Chemical Company).

In accordance with the present invention, a suitable c) compatible seed polyol may be a PIPA polyether seed polyol formed by reacting at least one aromatic diisocyanate, described below, in the presence of an excess of polyol in a polyol mixture of (i) an ethoxylated or oxyethylene end-capped polyol or a triol initiator with alkylene oxide containing from 15 to 80 wt. % of ethylene oxide, based on the total weight of the alkylene oxide, and (ii) one or more co-reactant polyol having a nitrogen or phosphorus atom and a formula molecular weight of up to 400, or, preferably, up to 300, wherein the polyol mixture comprises at least 70 wt. % of the ethoxylated or oxyethylene end-capped polyol. To provide for seed polyols useful for making high resilience foams, the seed polyol forming mixture comprises polyols having at least 45 wt. % or, preferably, at least 75 wt. % or, preferably, at least 80 wt. % of hydroxyl groups in the polyol mixture as primary hydroxyl groups. The isocyanate index is kept below 100 to keep a PIPA forming co-reactant present in the seed polyols. Amounts of the g) at least one polyisocyanate may provide at an isocyanate index of from 50 to less than 100, such as from 50 to 90, or, preferably, from 60 to 90 in the seed polyol forming mixture.

In accordance with the present invention, a suitable d) co-reactant polyol may be a diol or triol or oligoether diol having a formula weight of 400 or less, such as triethanolamine (TEOA), or diethanolamine (DEOA). Suitable co-reactant polyols d) may include diols, such as dihydric alcohols having a molecular weight from 62 to 399, especially the alkane polyols such as glycols, like ethylene glycol, propylene glycol, hexamethylene diol, low molecular weight alcohols containing ether groups such as diethylene glycol, triethylene glycol, dipropylene glycol, tripropylene glycol or butylene glycols; triols, such as glycerol, trimethylol propane or trimethylol ethane; or higher functionality alcohols, such as polyglycerine; and alkanolamines, such as monoethanolamine, diethanolamine, triethanolamine, triisopropanolamine, 2-(2-aminoethoxyethanol), diisopropanolamine, TEOA, DEOA and mixtures thereof. Other alkanolamines which may be considered include N-methylethanol-substituted alkanolamines, phenyldiethanolamines, and diglycol amines. Preferably, the c) one or more co-reactant polyols comprises an amine containing polyol, such as triethanolamine.

In accordance with the present invention, the silicon containing PIPA polyether polyol dispersion comprises particles of the silicon containing PIPA polyether polyol having two or more carbamate groups. These groups result from reaction of hydroxyl groups in the polyether polyol carrier and polyether polyol particles and g) a polyisocyanate. In accordance with the present invention, the f) one or more polyisocyanate, may comprise an aromatic diisocyanate, aromatic polyisocyanate or mixture of two or more of these. Examples of useful polyisocyanates in accordance with the present invention may include m-phenylene diisocyanate, toluene-2,4-diisocyanate, toluene-2,6-diisocyanate, naphthylene-1,5-diisocyanate, 1,3- and/or 1,4-bis(isocyanatomethyl) cyclohexane (including cis- and/or trans isomers), methoxyphenyl-2,4-diisocyanate, diphenylmethane-4,4′-diisocyanate, diphenylmethane-2,4′-diisocyanate, hydrogenated diphenylmethane-4,4′-diisocyanate, hydrogenated diphenylmethane-2,4′-diisocyanate, 4,4′-biphenylene diisocyanate, 3,3′-dimethoxy-4,4′-biphenyl diisocyanate, 3,3′-dimethyl-4-4′-biphenyl diisocyanate, 3,3′-dimethyldiphenyl methane-4,4′-diisocyanate, 4,4′,4″-triphenyl methane triisocyanate, toluene-2,4,6-triisocyanate and 4,4′-dimethyldiphenylmethane-2,2′,5,5′-tetraisocyanate. Diphenylmethane-4,4′-diisocyanate, diphenylmethane-2,4′-diisocyanate and mixtures thereof are herein referred to as “MDI”. Toluene-2,4-diisocyanate, toluene-2,6-diisocyanate and mixtures thereof are generically referred to as TDI. Specific useful polyisocyanates may include MDI, TDI, diphenylmethane-4,4′-diisocyanate, diphenylmethane-2,4′-diisocyanate, toluene-2,4-diisocyanate, toluene-2,6-diisocyanate or mixtures thereof.

In the silicon containing PIPA polyether polyol dispersion and methods for making it, suitable amounts of the g) one or more polyisocyanate, preferably, an aromatic diisocyanate, range from the amount needed to provide an isocyanate index of from 50 to less than 100, such as from 50 to 90, or, preferably, from 60 to 90.

In accordance with the present invention, the f) catalyst for the reaction of the alkoxysilane and water may be any material that catalyzes the hydrolysis of the alkoxysilane to form a silanol intermediate. The f) catalyst requires water to operate. Acidic and basic catalysts are useful, with basic catalysts being generally preferred. Acidic catalysts tend to promote branching and to produce silicate particles that are often irregular in shape and size, whereas basic catalysts tend to produce more spherical particles. Water-soluble catalysts and catalysts that are volatile or form volatile decomposition products that can be removed from the product dispersion by stripping are generally preferred. “Volatile” as used herein means the material under consideration has a boiling temperature of no greater than 70° C. at one atmosphere pressure. Examples of suitable catalysts may include mineral acids such as hydrochloric acid, hydrofluoric acid and sulfuric acid; organic acids such as p-toluenesulfonic acid, acetic acid and fluoroacetic acid; alkali metal hydroxides, alkali metal alkoxides, alkaline earth hydroxides, alkaline earth alkoxides, tertiary amine compounds, ammonia, ammonium hydroxide and quaternary ammonium compounds. Ammonia and ammonium hydroxide are especially preferred. Ammonia may comprise aqueous ammonia solution in which part or all of the ammonia may be in the form of ammonium hydroxide (NH₄OH). Preferably, the a) alkoxysilane or the f) catalyst is added last. For example, e) water, polyol(s) b), c) and d), and alkoxysilane a) are combined, followed by the addition of the catalyst f). Alternatively, the e) water, polyol(s) b), c) and d), and f) catalyst may be combined, followed by the addition of the alkoxysilane a).

In accordance with the present invention, the PIPA polyether polyol dispersion reacts to form a polyether polyol particle population in the polyether polyol carrier without the addition of any tin containing catalysts. The resulting PIPA polyether polyol dispersion in accordance with the present invention has a solids content of from 10 to 25 wt. %, based on the weight of the polyether polyol dispersion. The PIPA polyether polyol particles in accordance with the present invention are uniformly distributed in the polyether polyol carrier and may have a weight average particle size of from 0.2 to 4.5 μm or, preferably, from 0.2 to 2 μm. The dispersion of the PIPA polyether polyol in the polyether polyol carrier further has a stable dynamic viscosity as determined in accordance ASTM D4878 (2015) of from 1500 to 3950 cP at room temperature, preferably, from 2000 to 3900 cP.

In accordance with the present, the method of making the silicon containing polyisocyanate polyaddition (PIPA) polyether polyol dispersion comprises: forming a polyol mixture under shear while heating to reach a temperature of from 40 to 70° C. of a) at least one alkoxysilane in which the alkoxy groups each independently contain 1 to 4 carbon atoms, b) one or more polyether polyols or ethoxylated or oxyethylene end-capped polyols, each having a hydroxyl equivalent weight of from 500 to 4000 and an average of from 2 to 8, or, more preferably, from 2 to 6, or, even more preferably, from 2 to 3.5 hydroxyl groups per molecule, c) one or more compatible seed polyols having a weight average particle size of less than 2.5 μm, preferably, a PIPA polyether seed polyol, d) one or more co-reactant polyols having an hydroxyl equivalent weight of up to 400, preferably, containing at least one nitrogen atom, more preferably a tertiary nitrogen atom, and e) water to form a homogeneous dispersion; slowly adding under shear while maintaining the temperature for forming the polyol mixture, such as dropwise over a period of from 1 to 8 hours, f) a catalyst for the reaction of the alkoxysilane and water, preferably, a volatile catalyst, such as ammonia, for example 28% w/w aqua ammonia, to form a reaction mixture; stripping the reaction mixture to remove residual water and volatiles at from 50 to 80° C. and reduced pressure to form a base polyol dispersion; mixing under shear the base polyol dispersion for from 45 to 180 seconds; and, adding under continued mixing under shear g) one or more polyisocyanates, such as a diisocyanate, preferably, an aromatic diisocyanate, in an amount to provide an isocyanate index of from 50 to less than 100, such as from 50 to 90, or, preferably, from 60 to 90, and produce a silicon containing PIPA polyether polyol dispersion in a continuous phase of a polyether polyol.

Acceptable shear rates may range from 8 to 60 s⁻¹, or, preferably from 10 to 40 s⁻¹. Further, to provide silicon containing PIPA polyether polyols for use in making high resilience foams, the hydroxyl groups in the polyol mixture may comprise at least 45 wt. %, or, preferably, at least 75 wt. % of primary hydroxyl groups, based on the total weight of hydroxyl groups in the polyol mixture.

In the methods of making a base polyol dispersion of the silicon containing polyether polyol particles in a polyether polyol carrier in accordance with the present invention, the f) catalyst is a combination of water and catalyst, such as aqua ammonia. Suitable amounts of e) water may range from 4 to 8 wt. %, based on the total weight of the reaction mixture, or one or more moles, such as 1 to 2 moles of water per mole of the at least one alkoxysilane. Suitable amounts of the f) catalyst for the reaction of the alkoxysilane and water may range from 4 to 8 wt. %, based on the total weight of the reaction mixture. All wt. % s in the reaction mixture add up to 100%.

Preferably, the method of making the silicon containing PIPA polyether polyol dispersion from a base polyol dispersion of a silicon containing polyether polyol in a polyether polyol carrier takes place in two steps and comprises: mixing under shear while heating to a temperature of from 40 to 70° C. for a first period of 40 to 120 seconds a base polyol dispersion of a silicate, alkoxy silane, or oxyalkylenoxy silane group containing polyether polyol in a polyether polyol carrier; adding at the end of the first period while continuing the mixing under shear g) one or more polyisocyanates, such as a diisocyanate, preferably, an aromatic diisocyanate, and h) a catalyst, such as tin free catalyst or a divalent metal salt, preferably, a zinc fatty acid salt, in the amount of from 0.1 to 0.5, or, preferably from 0.2 to 0.4 wt. %, based on the weight of the base polyol dispersion, and continuing mixing under shear until the exotherm of the homogeneous dispersion ceases. Preferably, adding the h) catalyst takes place after a second period of from 30 to 90 seconds beginning at the end of the first period. Acceptable shear rates may range from 8 to 60 s⁻¹. Further, to provide silicon containing PIPA polyether polyols for use in making high resilience foams, the hydroxy groups in the polyol mixture may comprise at least 45 wt. %, or, preferably, at least 75 wt. % of primary hydroxyl groups, based on the total weight of hydroxyl groups in the polyol mixture.

The base polyol dispersion of the silicon containing polyether polyol in a polyether polyol carrier in accordance with the present invention may be formed by: mixing under shear to a polyol mixture of a) at least one alkoxysilane in which the alkoxy groups each independently contain 1 to 4 carbon atoms, b) one or more ethoxylated or oxyethylene end-capped polyols, each having a hydroxyl equivalent weight of from 500 to 4000 and an average of from 2 to 8, or, more preferably, from 2 to 6, or, even more preferably, from 2 to 3.5 hydroxyl groups per molecule, or, yet even more preferably, a nominal hydroxyl functionality of three, c) one or more compatible seed polyols having a weight average particle size of less than 2.5 μm, for example, a particulate branched polyether seed polyol containing two or more carbamate groups, preferably, a PIPA polyether seed polyol, or, more preferably, a PIPA polyether seed polyol containing two or more an aromatic carbamate groups, and d) one or more co-reactant polyols having an hydroxyl equivalent weight of up to 400, preferably, containing at least one nitrogen atom, more preferably a tertiary nitrogen atom form a homogeneous mixture; heating while stirring the homogenous mixture to from 40 to 70° C., and, slowly adding a f) catalyst for the reaction of alkoxy silane and water while continuing to shear the heated homogeneous polyol mixture for from 30 minutes to 12 hours, to form a base polyol dispersion.

The silicon containing PIPA polyether polyol dispersion in accordance with the present invention may be reacted with a polyisocyanate component, such as an aromatic diisocyanate, to form a polyurethane foam in a foam forming mixture. The foam forming mixture may further include one or more foam forming additives or blowing agents, such as water in the silicon containing PIPA polyether polyol dispersion component. The polyisocyanate preferably comprises at least one diisocyanate, preferably an aromatic diisocyanate. Suitable polyisocyanates in the polyisocyanate component in the foam forming mixture are the same as the f) one or more polyisocyanate used in making the PIPA polyether polyol dispersion and are, preferably, an aromatic diisocyanate.

In the foam forming mixture in accordance with the present invention, the reaction of the PIPA polyether polyol component and the polyisocyanate component to form a foam may be catalyzed. In accordance with the foam forming mixture of the present invention, a i) catalyst in the PIPA polyether polyol dispersion component comprises an amine catalyst, such as a tertiary amine, for example, in the amount of from 0.1 to 1 wt. %, based on the total weight of the PIPA polyol dispersion. Preferably, the amine catalyst is a tertiary amine that volatilizes during reaction and thus functions in part as a blowing agent, for example, bis (N,N-dimethylaminoethyl)ether.

In accordance with the foam forming mixture of the present invention, foam forming additives may include at least one blowing agent. Such additives are generally combined with the silicon containing PIPA polyether polyol dispersion as a component separate from the polyisocyanate component. Exemplary blowing agents include water, methylene chloride, carbon dioxide, and hydrocarbons. For example, water may be used in an amount from 1.0 to 7.0 wt. % (e.g., 2.5 to 5.0 wt. %), based on the total weight of the foam forming mixture. The foam forming additive may include at least one optional foam-stabilizing surfactant, e.g., that helps stabilize the gas bubbles formed by the blowing agent during the foaming process. For example, the foam-stabilizing surfactant may be a silicone surfactant known in the art (such as an organosilicone surfactant). The foam forming additive may include a chain extender, a cell opener, a filler (such as melamine and/or calcium carbonate), a pigment, a colorant, a reinforcing agent, a biocide, a preservative, an antioxidant, an autocatalytic polyol, and/or a catalyst (e.g., a blowing catalyst, a gelling catalyst, and/or a reactive catalyst).

The foams of the present invention find use in bedding and furniture, or padding therefore, such as pillows, mattresses and cushions for chairs and sofas as well as layers in the same, such as mattress toppers in European style mattresses.

### Examples

The following examples illustrate the present invention. Unless otherwise indicated, all temperatures are ambient temperatures (21-24° C.), all pressures are 1 atmosphere and relative humidity (RH) is 35%. Notwithstanding that the numerical ranges and parameters setting forth the broad scope of the invention are approximations, numerical values set forth in the specific examples are reported as precisely as possible. Any numerical value inherently contains certain errors necessarily resulting from the standard variation found in their respective testing measurements.

The materials used in the Examples and not otherwise defined, below, are set forth in Tables 1 and 2, below. Abbreviations used in the examples include: DEOA: Diethanolamine; Dow: The Dow Chemical Company, Midland, MI; IPA; Isopropyl alcohol; PEG: polyethylene glycol; EO: Ethylene oxide; PO: propylene oxide; HEW: Hydroxyl equivalent weight.

TABLE 1
Materials Used In Synthesis of PIPA
Polyether Polvols And in Foam Forming

| | | OH | Func- |
|---|---|---|---|
| | | num- | tion- |
| Ingredient | Description | ber | ality |
| Polyether | EO capped polyol triol, primary | 35.5 | 3 |
| Polyol 1 | OH = 88%, EO % = 19, HEW = | | |
| | 1580; a VORANOL ™ polyol | | |
| | product (The Dow Chemical | | |
| | Company) | | |
| Seed Polyol | PIPA polyether polyol (13.6% EO, | 62 | 3 |
| (PSD (x90) | primary OH = 80%, from TDI 20 | | |
| ~<2.5 μm) | wt. % solids in Polyether polyol 1, | | |
| Triethanolamine | CAS NO. 102-71-6, Sigma-Aldrich, | 753 | 3 |
| (TEOA) | St louis, MO (99 wt. %) | | |
| Silica Triol | Base polyol dispersion (Ex. 6 of | 29.5 | — |
| (see text below) | Example 6 of US publication No. | | |
| | US20200369845A1 | | |
| Tetraethyl | CAS NO. 78-10-4, 98% (C₂H₅O)₄Si | — | — |
| orthosilicate | Sigma-Aldrich | | |
| (TEOS) | | | |
| Polyether | EO capped polyol triol, primary | 34 | 3 |
| Polyol 2 | OH = 48%, EO % 70%, HEW = | | |
| | 1650; a VORANOL ™ polyol | | |
| | product (The Dow Chemical | | |
| | Company) | | |
| Polyether | EO capped polyalkoxylated glycerol, | 37.5 | 3 |
| Polyol 3 | primary OH = >50%, EO % 20%; | | |
| Crosslinker | Blend of PEG 400, Sorbitol and urea | 645 | — |
| | with 25% water content (Evonik AG, | | |
| | Essen, DE) ORTEGOL ™ 204 resin | | |
| NH₄OH | Ammonia Solution (35% w/w in | 1602 | — |
| | water), CAS# 7664-41-7 | | |

The silicate containing polyether triol or silica triol in Table 1, above, is a base polyol dispersion made in accordance with Example 6 of publication No. US20200369845A1 to Turunc et al. from Polyether Polyol 3 made by propoxylating and then ethoxylating glycerol to produce a 1550 hydroxyl equivalent weight, nominally trifunctional block copolymer containing 20% by weight polymerized ethylene oxide and mainly primary hydroxyl groups having a hydroxyl equivalent weight of 1550. To form the silica triol base polyol dispersion using a sol-gel method, 100 pbw of Polyether Polyol 1, 40 pbw of TEOS and 10 pbw of water were placed in a round bottom flask equipped with a mechanical stirrer and mixed until homogeneous. The mixture was heated while stirring until the temperature reached 50° C. Then, 12 pbw of ammonia solution (aqua ammonia) was slowly added to form a reaction mixture while stirring for 4 hours. The volatiles and water were stripped at 70° C. under reduced pressure. A 10 wt. % solids base polyol dispersion of a silicate containing polyether polyol in a polyether polyol was obtained (wt. % calculated from formulation). The hydroxyl number of the obtained product is 29.5 mgKOH/g.

Table 3, below, summarizes the PIPA polyether polyol dispersion synthesis steps including timing of addition. PIPA polyether polyol dispersions, the indicated ingredients were weighed separately and combined in a plastic container in the proportions and in the order and timing indicated and mixed at a shear rate of 1200 rpm or 20 s⁻¹ and is slowed to 500 rpm or 8.33 s⁻¹ after 4 minutes and continued until the temperature starts to drop. The polyether polyol was mixed together with the silica triol, seed polyol, TEOA and after 60 sec the pre-weighted isocyanate portion with zinc salt catalyst was added. During the process, a thermometer measured the exotherm to control the reactivity and timing was controlled to the second. The total amount of the PIPA polyether polyol dispersion made in each example was 500 g.

TABLE 2
Additives Used In PIPA polyether Polyol
Dispersion Synthesis And For Foaming

| Ingredient | Description |
|---|---|
| Silicone | Silicone surfactant used for viscoelastic |
| Surfactant 1 | TDI foams, TEGOSTAB ™ B8783 LF2 |
| | surfactant (Evonik) |
| Amine | 70 wt. % bis-dimethylaminoethyl ether |
| Catalyst 1 | solution in dipropylene glycol (NIAX ™ |
| | A1 polyol, Momentive, Inc., Phila., PA) |
| Amine | 33 wt. % solution of triethylene diamine |
| Catalyst 2 | in dipropylene glycol (DABCO ™ 33LV |
| | catalyst, Evonik) |
| Tin Catalyst | Tin gelation Catalyst - stannous octoate |
| | catalyst, also known as tin(II) 2-ethylhexanoate |
| | (KOSMOS ™ 29 catalyst, Evonik) |
| Zinc Salt | VOC free zinc ricinoleate catalyst, OH#: |
| catalyst | 300 mg KOH/g, viscosity 1470 mPas as reported |
| | by mfgr. (KOSMOS ™ 54 catalyst, Evonik) |
| Isocyanate | A mixture of the 2,4 and 2,6 isomers of toluene |
| or TDI | diisocyanate in a ratio of 80% to 20%. % |
| | NCO = 48.23 (VORANATE ™ T-80 resin, Dow) |
| Liquid flame | alkyl phosphate flame retardant containing |
| retardant | Tris(2-chloroisopropyl) phosphate (FYROL ™ |
| | TCPP, ICL Group Ltd., Tel Aviv, IL) |

Test Methods: In the Examples that follow, several test methods were used which are identified in Tables 4 and 5, below, and/or in the following text. Unless otherwise stated, all tests were run three times and the average result was reported. Standard deviations in all data were within acceptable limits.
Dynamic Viscosity (25° C.) refers to the viscosity as determined in accordance ASTM D4878 (2015) using a Bohlin C-VOR Rheometer (Malvern, Worcestershire, UK) equipped with a DIN C25 coaxial cylinder having a bob diameter of 25 mm.
PSD average refers to the particle size diameter, as determined by laser light scattering, of a concentrated solution or dispersion of the indicated analyte in IPA (20-30 ml IPA+0.5 g analyte) using a Beckman Coulter LS 13 320 particle size analyzer (Beckman Coulter, Brea, CA). PSD is reported as the diameter of particles in the dispersion at which 90%, by volume, are measured as having less than the specified volume particle diameter.
Solids Content: PIPA polyether polyol dispersions were analyzed by low-resolution pulsed NMR spectroscopy Quantization was performed by comparing the intensity of the NMR signal of the analyte with the intensity of the NMR signal of a corresponding unreacted mixture of the ethoxylated or oxyethylene end-capped polyol, the co-reactant polyol and any co-reactant polyol. The signal intensities were determined at 70 ρs. An absolute NMR reading was also performed independently to calibrate reference samples. The parameters summarized below in Table A were used to validate of the method and are provided only as guidelines for setting up the method.

The solids content of the PIPA polyether polyol dispersions were calculated, as follows:

$$S = ( 1 - \frac{{b}^{′}}{{a}^{′}} \cdot \frac{dpol}{dPIPA} ) \times 100 \%$$

Where:
S=the solids content (% (w/w)) of the analyte;
b′=the signal (Volt) for the PIPA sample, corrected for the offset;
a′=the signal (Volt) for the polyol standard, corrected for the offset;
dpol=the density (g/cm³) of the polyol standard; and,
dPIPA=the density (g/cm) of the PIPA sample.

TABLE A
NMR Parameter Guidelines

| | |
|---|---|
| Status: | |
| Serial No.: | ND2578 |
| MBox Temp. [C.]: | 40.003 |
| Temp. Err. [C.]: | 0.003 |
| Temp. Control: | ON |
| Parameters: | |
| Scans: | 25 |
| Rd [s]: | 5.00 |
| Gain [dB] | 61 |
| Dig. Bw [Hz]: | 20000 |
| Ana. Bw: | broad |
| Offset Comp.: | off |
| Det. Mode: | magnitude |
| Magnitude Mode: | DIODE |
| Dig. Res.: | fast |
| Dummy Shots: | 0 |
| Pulse Atten[dB]: | 0 |
| Gradient Unit: | none |
| Settings: | |
| 90 Pls.Len.[us]: | 1.84 |
| 180Pls.Len.[us]: | 3.76 |
| DetAngle.B[deg]: | 261 |
| DetAngle.N[deg]: | 265 |
| H Offs. [Steps]: | 438 |
| NMR Freq. [MHz]: | 19.950000 |
| Pulse Atten [dB]: | 0 |
| Instr.Gain [db]: | 61 |
| DeadTime [ms]: | 0.011 |
| Homog. Limit [ms]: | 0.50 |
| Instr. Rd [s]: | 1.50 |
| Stat Grad X [%]: | 0.00 |
| Stat Grad Y [%]: | 0.00 |
| Stat Grad Z [%]: | 0.00 |
| SFC: | no |

Whiteout time: Measures rate of development of particles size accelerates and refers to the time after addition of all materials into the reaction mixture in which the mixture turns from transparent to a white color. Acceptable results are 4 to 6 minutes or less. Results longer than 8 min normally lead to damaged polyol.

The PIPA polyether polyol dispersions made in Table 3 as inventive Examples 1, 2 and 3, above, are stable, and applicable in foam formulation. Error! Reference source not found., below, summarizes the observations made in the synthesis of the PIPA polyether polyol dispersions. The most reliable PIPA polyether polyol dispersions comprise the result of adding the zinc catalyst after the polyisocyanate at the last part in the synthesis.

TABLE 3
PIPA Polyether Polyol Dispersion Synthesis

| | Example | | | | | | | | | |
|---|---|---|---|---|---|---|---|---|---|---|
| | Comparative 1 | | Inventive 1 | | Comparative 2 | | Inventive 2 | | Inventive 3 | |
| | | Time to | | Time to | | Time to | | Time to | | Time to |
| Ingredient | Amount | add (s) | Amount | add (s) | Amount | add (s) | Amount | add (s) | Amount | add (s) |
| Polyether Polyol | 78 | 0 | 39 | 0 | 19.5 | 0 | 19.5 | 0 | 0 | |
| 1 | | | | | | | | | | |
| Silica triol | | | 39 | | 58.5 | 0 | 58.5 | 0 | 78 | 0 |
| Seed Polyol | 2 | 0 | 2 | 0 | 2 | 0 | 2 | | 2 | 0 |
| Triethanolamine | 9 | 0 | 9 | 0 | 9 | 0 | 9 | 0 | 9 | 0 |
| (99%) | | | | | | | | | | |
| ISOCYANATE | 11.05 | 60 | 11.05 | 60 | 11.05 | 60 | 11.05 | 60 | 11.05 | 60 |
| Zinc Salt Catalyst | 0.2 | 60 | 0.2 | 60 | 0.2 | 60 | 0.2 | 90 | 0.2 | 90 |
| Index | 71 | — | 71 | — | 71 | — | 71 | — | 71 | — |

TABLE 4
PIPA Polyether Polyol Properties and Synthesis Observations

| Example | Comparative 1 | Inventive 1 | Comparative 2 | Inventive 2 | Inventive 3 |
|---|---|---|---|---|---|
| Observations | | | | | |
| Whiteout time (s) | 10 | 12 | 18 | 15 | 14 |
| Reaction Temperature | — | 62 | 61 | 62 | 62 |
| @ 1 min (° C.) | | | | | |
| Reaction Temperature | — | 61 | 54 | 60 | 62 |
| @ 5 min (° C.) | | | | | |
| Mixing Time (min) | — | 4 | 4 | 4 | 4 |
| State (after mix)* | — | L | V | L | L |
| State (after 1 h)* | — | L-V | V | V | V |
| State (after 24 h)* | — | L-V | P | V | V |
| Dynamic Viscosity, | 2942 | 3050 | N/A¹ | 3100 | 3014 |
| 25° C. (mPas) | | | | | |
| OH number (mg KOH/g) | 60 | 60 | N/A¹ | 60 | 60 |
| PSD average | 1.2 | 0.9 | N/A¹ | 0.9 | 0.9 |
| (x90, μm) | | | | | |
| Solid content | 20.3 | 20.8 | N/A¹ | 21 | 20 |
| (nmr, wt. %, | | | | | |
| Nominally | | | | | |
| 20~21%) | | | | | |

*Visual Observations: L—liquid, V—viscous, P—paste, S—solid, G—gel, B—blob.
¹N/A—not applicable as not measurable.

As shown in Table 4, above, Comparative Example 1 is a prior art formulation without any silicon containing materials and stands as a benchmark for test and process parameters, such as physical properties and time intervals for addition of ingredients and overall process time. Inventive Examples 1, 2 and 3 result in stable polyols with improved particle size and physical properties to produce foams. In Inventive Example 1, roughly 11 wt. % of TEOS from the silica triol gave a useful silicon containing PIPA polyether polyol dispersion without delaying addition of catalyst. Inventive Examples 2 and 3 demonstrate successful use of a large amount of TEOS from the silica triol in the reaction mixture resulting from delaying addition of the catalyst. Inventive Examples 1, 2 and 3 exhibited higher but acceptable viscosity than the Comparative Example 1 and smaller average particle size. In Comparative Example 2, high levels of silica triol result in fast viscosity build up and particle size growth in the initial reaction. Thus, in Comparative Example 2, the produced PIPA polyether polyol turns into a gel or solid after 24 hr. In accordance with the present invention, a higher amount of silicon has been introduced in the PIPA polyether polyol particles; and the improved properties of the final polyether polyol dispersion are with the scope of the present invention. As shown below, formulations containing TEOS proved effective in accommodating the inventive process while also improving the FR properties of the resulting foams.

The PIPA polyether polyol dispersions accordance with the present invention and Examples, above, were used in foam formulations indicated in Table 6, below, and were tested in the manner indicated above and/or in Table 4, above, and Table 5, below. The foams were made according to a standardized hand-mix procedure wherein a FOAMAT™ Foam Qualification System (Format Messtechnik GmbH, Karlsruhe, DE) recorded foam-processing characteristics such as foam rise, height, reaction temperature and rise pressure. 20×20×20 cm boxes or 30×30×25 cm boxes (for Crib 5) were used. All ingredients with the exception of the isocyanate, and stannous octoate (tin catalyst) were stirred with a propeller mixer driven by a high shear mixer for 30 s at 2500 rpm (˜416 s⁻¹). Then tin catalyst was added, and stirring was continued for an additional 10 s. After completing this 40 s mix time, TDI was added and stirred for an additional 10 s. The fluid material was then poured into the box. Rise time and settling were measured. After finishing the foam processing, prepared foam was post cured in at oven with warm air circulation at 413 K (140° C.) for 300 s. After removing from the oven, foams were crushed by hand and a relative rating for their tightness was assigned based on the needed crushing strength. The foams were observed as enabling consistent processing and foam tightness.

TABLE 5
Foam Testing Methods

| Name of Test | Standard | Summary |
|---|---|---|
| Density core | ISO-845 | 2 Samples (100 × 100 × 50 mm) |
| | | without skin |
| CFD | ISO-3386-1 | 2 Samples (100 × 100 × 50 mm) |
| | | without skin |
| Tensile | ISO-1798 | 3 samples with 10-15 mm thickness |
| strength/ | | cut at standard defined shape. |
| Elongation | | |
| Tear strength | ISO-8067 | 3 samples size 125 × 25 × 25 mm |
| Resilience | ASTM-D3574-16 | 2 samples size 100 × 100 × 50 mm |
| Air flow | ISO-7231 | 3 samples size 51 × 51 × 25 mm, |
| | | crushed before test |
| Compression | ISO-1856 | 6 samples size 51 × 51 × 25 mm |
| set | | tested at 75%/and 90% RH for 22 |
| | | h-at-70° C., measurements of |
| | | recovered height after 30′ |
| Wet | ISO-13362 | 2 samples size 100 × 100 × 50 mm, |
| compression | | 70% compressed, tested at 95% RH |
| set | | for 22 h/40° C./measurements of |
| | | recovered height after 15′ |
| Flammability | CAL 177 with | 5 samples fresh and 5 samples aged; |
| | FIG. 117-A | size305 × 76 × 12.7 mm |
| | sample holder | |
| | BS5852 Crib 5 | White Fabric applied for cover, |
| | | foams are crushed. [Size: 450 × |
| | | 450 × 75 + 450 × 300 × |
| | | 75 mm] |
| Viscosity | Bohlin Dynamic | 25° C.; 1-60-1 Hz; 1 Hz/second |
| | Viscosity | |

TABLE 6
Foam Forming Mixtures

| | PIPA | | | |
|---|---|---|---|---|
| | Polyether | Comp. | | |
| Examples | Polyol | 3 | Inv. 4 | Inv. 5 |
| INGREDIENTS | | | | |
| Polyether Polyol 1 | | 49.00 | 49.00 | 0 |
| PIPA polyether polyol of | Comp. 1 | 50.00 | | |
| Comp. 1 | | | | |
| Polyether Polyol 2 | | 1.00 | 1.00 | 1.00 |
| PIPA polyether polyol of Ex 3 | Inventive 3 | | 50.00 | 99.00 |
| Amine Catalyst 1 | | 0.03 | 0.03 | 0.03 |
| Amine Catalyst 2 | | 0.13 | 0.13 | 0.13 |
| DEOA 85% (w/w) | | 0.75 | 0.75 | 0.75 |
| Crosslinker | | 1.50 | 1.50 | 1.50 |
| Silicone Surfactant 1 | | 0.50 | 0.50 | 0.50 |
| Liquid Flame Retardant | | 5.00 | 2.50 | — |
| Tin Catalyst | | 0.17 | 0.17 | 0.17 |
| Water | | 1.80 | 1.80 | 1.80 |
| TDI | | 34.14 | 36.25 | 36.25 |
| Isocyanate Index | | 105 | 105 | 105 |

As shown in Table 7, below, the foams of Inventive Example 5 containing the inventive PIPA polyether polyol dispersions made from just over 22 wt. % of tetraethoxysilane passed the CAL 117 and the CRIB 5 results tests without other flame-retardant (FR) additives when. The foams of Inventive Example 4 containing the PIPA polyether polyol dispersions made from just over 11 wt. % of tetraethoxysilane with passed the CRIB 5 tests without other flame-retardant (FR) additives a total of two out of five (2 of 5) times. The physical properties of the foam of Inventive Example 5 included improved density, tear strength and airflow. The physical properties of the foam of Inventive Example 4 exhibited improved tear strength.

TABLE 7
Foam Physical and Flame Retardant Properties

| Example | Comp. 3 | Inv. 4 | Inv. 5 |
|---|---|---|---|
| Physical Mechanical Properties | | | |
| Density (kg/m³) | 28.4 | 28.2 | 32.4 |
| CFD 40% (kPa) | 2.9 | 2.7 | 4.8 |
| CFD SAG | 2.8 | 2.7 | 4.0 |
| CFD Hysteresis (%) | 67.2 | 68.1 | 54.3 |
| Tear strength (N/m) | 255.0 | 276.3 | 296.3 |
| Resilience (%) | 36.0 | 41.5 | 41.5 |
| Air flow uncrushed (scfm) | 1.5 | 1.1 | 1.7 |

Flammability Tests

| | | | |
|---|---|---|---|
| Crib 5 Pass/Fail | PASS | FAIL¹ | PASS |
| Crib 5, Weight Loss/g (pass <60 g) | 39 | 62 | 43 |
| Crib 5, Self-extinguish | YES | YES | YES |
| Crib 5, Time to Extinguish/s (pass <600 s) | 375 | 482 | 416 |
| CAL 117 Pass/Fail | PASS | FAIL | PASS |
| CAL 117, Char length (cm) (Avg of 6 | 7.5 | 17 | 5.5 |
| or less) | | | |
| CAL 117, After flame (s) (Avg of 5 s | 3 | 8 | 4 |
| or less) | | | |

1. A silicon containing polyisocyanate polyaddition (PIPA) polyether polyol dispersion for use in making flexible polyurethane foams having inherent flame retardant properties comprises a polyether polyol carrier and from 10 to 25 wt. %, based on the total weight of the dispersion, of particles of a silicon containing (PIPA) polyether polyol that contain one or more silicate groups and one or more alkoxy silane, silanol or oxyalkylenoxy silane groups and that, further, contain two or more carbamate groups,
wherein the silicon containing PIPA polyether polyol has a particle size diameter (PSD) wherein 90%, by volume, of the particles in the dispersion have a maximum PSD of from 0.1 to 3 μm, and,
further wherein, the dynamic viscosity of the dispersion as determined in accordance ASTM D4878 (2015) ranges from 1500 to 5000 cP at 25° C.

2. The silicon containing PIPA polyether polyol dispersion as claimed in claim 1, wherein the polyether polyol carrier comprises b) one or more ethoxylated or oxyethylene end-capped polyols having a number average molecular weight of from 2000 to 12000 and an average hydroxyl functionality of from 2 to 8.

3. The silicon containing PIPA polyether polyol dispersion as claimed in claim 2, wherein the b) ethoxylated or oxyethylene end-capped polyether polyol carrier has an ethylene oxide content of from 15 to 80 wt. %, based on the total weight of alkylene oxides or alkylene oxide containing reactants used to form the polyether polyol carrier.

4. The silicon containing PIPA polyether polyol dispersion as claimed in claim 1, wherein the particles of the silicon containing PIPA polyether polyol contain two or more aromatic carbamate groups.

5. The silicon containing PIPA polyether polyol dispersion as claimed in claim 1, wherein the silicon containing PIPA polyether polyol particles further comprise, in copolymerized or condensed form, d) a co-reactant polyol having an hydroxyl equivalent weight of up to 400 and containing a nitrogen atom.

6. The silicon containing PIPA polyether polyol dispersion as claimed in claim 1, further comprising:
water or another blowing agent;
i) one or more catalysts; and,
g) as a separate component, one or more polyisocyanates, wherein a mixture of the silicon containing PIPA polyether polyol dispersion and the separate component comprises a foam forming mixture.

7. A method of making the silicon containing PIPA polyether polyol dispersion as claimed in claim 1 comprising:
forming a polyol mixture under shear while heating to reach a temperature of from 40 to 70° C. of a) from 10 to 25 wt. %, based on the total weight of the polyol mixture, of at least one alkoxysilane in which the alkoxy groups each independently contain 1 to 4 carbon atoms, b) from 53 to 80 wt. % of one or more polyether polyols having a hydroxyl equivalent weight of from 500 to 4000 and an average of from 2 to 8 hydroxyl groups per molecule, c) from 2 to 4 wt. % of one or more compatible seed polyols, d) from 6 to 18 wt. % of one or more co-reactant polyols, and e) water in the amount of from 2 to 5 moles per mole of the a) at least one alkoxysilane to form a homogeneous dispersion, all wt. % s in the polyol mixture, excluding e) water, adding up to 100%;
slowly adding while mixing under shear f) a volatile catalyst for the reaction of the alkoxysilane and water to form a reaction mixture;
stripping the reaction mixture to remove residual water and volatiles at from 50 to 80° C. and reduced pressure to form a base polyol dispersion of a silicon containing polyether polyol that contains one or more silicate, alkoxy silane, or oxyalkylenoxy silane groups in a polyether polyol carrier;
mixing under shear of from 8 to 60 s⁻¹ the base polyol dispersion for a first period of from 45 to 180 seconds;
at the end of the first period, adding to the base polyol dispersion while continuing the mixing under shear of from 8 to 60 s⁻¹ g) one or more aromatic polyisocyanates in an amount to provide a composition having an isocyanate index of from 50 to less than 100, and, h) a catalyst in the amount of from 0.1 to 0.5 wt. %, based on the total weight of the base polyol dispersion; and,
continuing the mixing under shear until the exotherm of the homogeneous dispersion ceases to produce a silicon containing PIPA polyether polyol dispersion in a continuous phase of a polyether polyol.

8. The method as claimed in claim 7, wherein at least one of the b) one or more polyether polyols comprises at least one ethoxylated or oxyethylene end-capped polyol having a number average molecular weight of from 2000 to 12000 and an average hydroxyl functionality of from 2 to 8.

9. The method as claimed in claim 7, wherein at least one of the d) one or more co-reactant polyols contains a nitrogen atom.

10. The method as claimed in claim 7, wherein at least 45 wt. % of the hydroxyl groups in the polyol mixture comprise primary hydroxyl groups, based on the total weight of hydroxyl groups in the polyol mixture.

11. The method as claimed in claim 7, wherein adding the h) catalyst takes place after a second period of from 30 to 90 seconds beginning at the end of the first period.
